(19) United States
(12) Patent Application Publication
(10) Pub. No.: US 2021/0308705 A1
(43) Pub. Date: Oct. 7, 2021

(54) SPRAYING DISPENSER WITH LEAK-PROOF VENT

(71) Applicant: RIEKE LLC, Auburn, IN (US)

(72) Inventors: Yen Kean LEE, Rohnert Park, CA (US); Yurui XIAO, Newhall, CA (US)

(21) Appl. No.: 17/262,817

(22) PCT Filed: Jul. 25, 2019
(86) PCT No.: PCT/US2019/043364

§ 371 Date: Jan. 25, 2021

Related U.S. Application Data
(60) Provisional application No. 62/702,938, filed on Jul. 25, 2018.

(51) Int. Cl. B05B 11/00

(52) U.S. Cl. CPC B05B 11/0044; B05B 11/3042

(57) ABSTRACT

A dispenser that also serves as a closure for transportable containers is described. The dispenser includes a trigger or other similar mechanism in which air must be admitted back into the container, usually by way of aperture. An insert is fitted into the aperture, with one or more tortuous paths circumscribed around the insert so as to permit air flow while simultaneously impeding and effectively preventing liquid from flowing out of the aperture when the container is inverted or otherwise rotated numerous times beyond its intended dispensing position (e.g., as might occur during transportation).

### CROSS REFERENCE TO RELATED APPLICATIONS

This application claims priority to, and incorporates by reference, U.S. Provisional Patent Application Ser. No. 62/702,938, filed on Jul. 25, 2018.

### FIELD OF INVENTION

The following disclosure and invention relate to a leak-proof dispenser mechanism that is selectively attachable to a container and, more specifically, to a trigger sprayer with an air vent insert having a tortuous path circumscribed on a plurality of its facings in order to effectively eliminate leakage through the vent aperture.

### BACKGROUND

Containers capable of transporting fluids, such as soaps or cleaning solutions, aqueous or oil-based liquids used in cooking, and other fluids, are increasingly required by retailers and e-commerce merchants who must ship such containers without fear of leakage or loss of the fluid. Therefore, in order to simplify filling, numerous closures having dispensing mechanisms have been developed to address this issue while simultaneously having the closure itself serve as the final dispenser. International Patent Application Serial No. PCT/US2017/051098, filed on Sep. 12, 2017 and published as WO2018049373 (and incorporated by reference herein), provides one such example.

These type of trigger sprayers need allow make-up air to flow back into the container after dispensing so as to avoid deformation of the container and/or inconsistent dispensing. Thus, vent passage to admit ambient air into the container. When present, it is usually integrated within the trigger/dispensing mechanism, as is shown in FIG. 1.

In particular, in FIG. 1, a trigger sprayer 10 is affixed to the open neck so as to serve as a closure for a container (not shown). In normal operation from an upright position (not shown), aperture 12 allows for air to be drawn back into the container after the trigger 10 has been activated. However, when the container is displaced from an upright positioned, a full column of liquid can flow along lines L through aperture 12 into a pocket/void space 17 between the aperture 12 and slidable, chevron 15 positioned on the moving trigger cylinder 18. In this manner, a portion of this liquid may be expelled from the pocket/void into the ambient environment, thereby resulting in leakage and loss of fluid from the container. If chevron 15 is not used, an unwanted flowpath is constantly present (or the vent aperture remains blocked throughout trigger activation).

The chevron 15 moves in concert with trigger activation so as to cause the protrusions 16 to slide past the aperture 12 in its normal and intended range of motion. At rest (i.e., when dispensing/trigger activation is not occurring), the protrusion 16 blocks exposure of the aperture 12 to the ambient environment. When in use or when temporarily exposed to rough handling and unexpected movement as often happens during e-commerce shipping (and as shown in FIG. 1), chevron 15 slides up, causing the trigger cylinder and protrusions 16 to move past aperture 12 and create a direct, temporary fluidic connection between the interior of the container and the ambient environment via aperture 12. As rest, the pocket/void space behind the cone of the insert still receives unwanted fluid if the trigger/container combination is inverted. Further, if the trigger/container combination is dropped or experiences sudden movement, the chevron may be displaced and/or the seal it forms may be temporarily deformed, thereby creating an intermittent opening to allow fluid to escape may occur.

Notably, air flow back into the container is imperative to avoid creating a pressure imbalance that could collapsing the container and/or impair dispensing and trigger activation. In essence, the expulsion of fluid from the container creates a vacuum unless/until air is permitted to flow into the container to equalize the pressure of the interior with the ambient environment.

U.S. Pat. No. 5,353,969 discloses spray pump with a spiral vent groove. The groove is of sufficient length to restrict the free flow of liquid (i.e., leakage) when the container is dispensed while inverted. In particular, the rate of liquid dispensed from the container must be greater than the flow of air through the vent groove, thereby creating a vacuum to suck-back air through the vent and into the container. Notably, this design is intended to allow for inverted dispensing without leakage, but the patent is silent as to whether leakage might otherwise occur when the container is inverted but not subject to the vacuum forces created when the trigger is dispensing fluid out of the container.

Other schemes for inverted dispensing and/or attempts to deal with venting and unwanted leakage are disclosed in U.S. Pat. Nos. 5,341,967; 4,875,933; and 5,899,366.

In view of the foregoing, a dispenser, and particularly a trigger sprayer, that avoids leakage when the container is jostled or inverted would be welcome. While conventional designs may limit such leakage to a relatively small amount, the complete elimination of this sort of minor dripping (or “burping”) would enable a dispensing container to be shipped without additional precautions and/or packaging.

Further, a design that incorporates many of the existing features and form factors found in current trigger sprayers would be particularly useful.

### SUMMARY

A dispenser that also serves as a closure for transportable containers is described. The dispenser includes a trigger or other similar mechanism in which air must be admitted back into the container, usually by way of aperture. An insert is fitted into the aperture, with one or more tortuous paths circumscribed around the insert so as to permit air flow while simultaneously impeding and effectively preventing liquid from flowing out of the aperture when the container is inverted or otherwise rotated numerous times beyond its intended dispensing position (e.g., as might occur during transportation). Additionally or alternatively, the tortuous flow path could be formed as a void space on the surface of the trigger body, with the closure (or some other element or insert) bounding and encasing the flowpath, thereby giving rise to a flowpath without necessarily resorting to an insert.

According to one aspect, the invention may include any combination of the following features:
a dispenser selectively ejecting fluid from a sealed container when the dispenser is actuated;
a venting component formed with or in the dispenser or the container, said component having a tortuous flowpath circumscribed on a plurality of facings of the component;
a venting aperture that aligns with the tortuous flowpath when the dispenser is actuated to admit ambient air into the container;
wherein the venting component comprises an insert fitted within a void space on an interior of the dispenser, said void space disposed between a pump and the venting aperture;
wherein the venting component cooperates with at least one of: a closure, the dispenser, and the container, to define the tortuous path;
wherein the tortuous flowpath includes a passageway that orthogonally changes direction at least once on at least one facing of the component;
wherein the orthogonal change of direction occurs on every facing of the component;
wherein the tortuous flowpath defines at least one U shape on at least one of the facings of the component;
wherein the tortuous flowpath defines a U shape on every of the component;
wherein a plurality of U-shapes are formed on a single facing;
wherein the component is a polygonal cylinder with a plurality of sidewalls and the tortuous flowpath is circumscribed on at least two of the sidewalls;
wherein the component includes a top facing and the tortuous flowpath is circumscribed on the top facing;
wherein the top facing is angled so that at least one sidewall has a longer length than a sidewall positioned opposite thereto; and
wherein the polygonal cylinder has four sidewalls or facings, in addition to a top facing and a bottom facing.

Specific reference is made to the appended claims, drawings, and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### BRIEF DESCRIPTION OF THE DRAWINGS

Operation of the invention may be better understood by reference to the detailed description taken in connection with the following illustrations. These appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings and attachments, all of which are incorporated as part of this disclosure:

FIG. 1 is a three dimensional cross sectional view of dispenser having a conventional venting aperture in communication with the pump, with arrows L indicating potential pathways through which fluid may escape when the container is inverted or otherwise handled (e.g., as might occur during shipping).

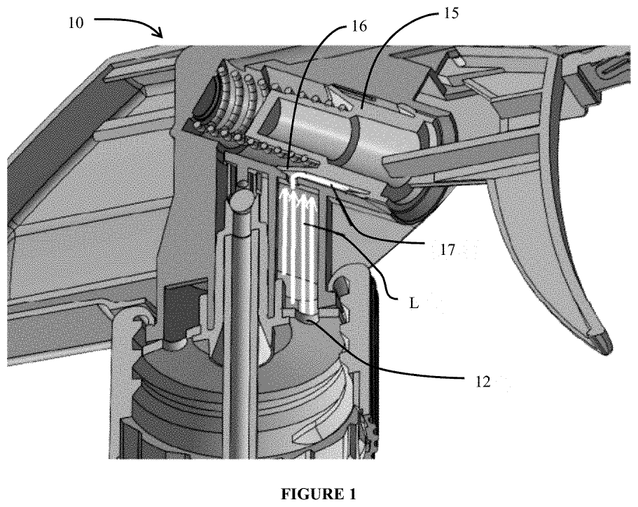

FIG. 2 is a cross sectional side view of a dispenser incorporating a “burp-free” insert to prevent unwanted leakage out of the container/dispenser combination according to certain aspects of the invention.

FIGS. 3A, 3B, and 3C are three dimensional illustrations of the insert appropriate for use in the combination shown in FIG. 2, with each shown from a different perspective to better highlight the zig-zagging and/or tortuous flowpath circumscribed around the facing of the insert, with starting and end points at opposing ends/edges of the insert.

FIG. 4 is a three dimensional sectional view of dispenser, similar to that of FIG. 1, but having an insert according to certain aspects of the invention disposed in the void between the venting aperture and the pump.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

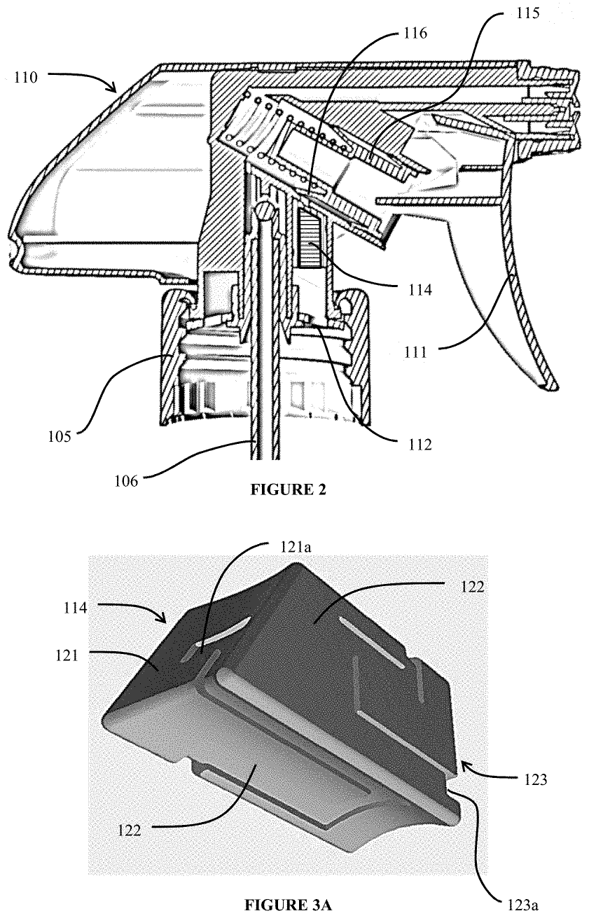

With reference to FIGS. 2 through 4, trigger sprayer 110 is affixed to a container (not shown) by way of a conventional connection, such as threaded collar 105. Insert 114 is positioned between the trigger activation mechanism 111 and the venting aperture 112 connecting to the interior volume of container. A dip tube 106 can be used to ensure fluid is drawn from the bottom of the container with minimal effort.

Insert 114 has a square cylindrical shape as shown, with the facings 121, 122, 123 of the cylinder angled to conform with adjacent components (i.e., aperture 112 and trigger activation mechanism 111). In some embodiments, insert 114 is solid or a hollowed cylindrical component with sufficient thickness to accommodate the conduit 120 described below. In a preferred embodiment, top facing 121 is angled relative to the bottom facing 123 so as to conform to the trigger activation mechanism 111 (and, more specifically, its interface with the slidable chevron 114 and protrusion 116 associated therewith). One or more of the sidewall facings 122 may be curved (concaved or convexed) or otherwise angled or shaped to conform with its adjacent components (e.g., the body of the pump mechanism, the dip tube, the outer shroud of the trigger itself, etc.).

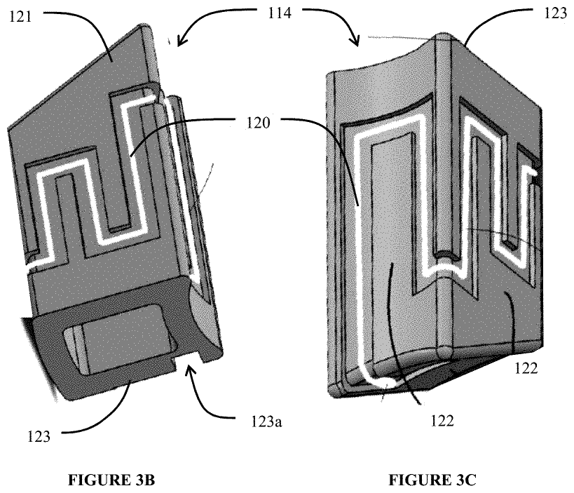

A single conduit 120 (highlighted by a white line in FIGS. 3B and 3C) is formed on and/or in insert 114. The conduit forms a tortuous path through which air must travel to be admitted into the interior. Notably a cone-shaped protrusion is formed in the activation mechanism 111 so that the insert 114 and its conduit 120 are only temporarily exposed to the ambient environment during a dispensing event.

The conduit 120 zig zags along at least one of the sidewall facings 122 of the insert 120. In this manner, in the event the container is inverted or otherwise jostled so that fluid flows through the aperture 112, the tortuous path ensures that fluid cannot flow directly through the conduit 120 and into the pocket/void 116 behind protrusion 115. In this manner, the possibility of loss or unwanted leakage from the pocket is effectively eliminated, primarily because the fluid cannot traverse the tortuous path to exit into the pocket/void.

As used herein, tortuous path means the zig zag path as shown on at least one of the insert facings on FIGS. 3A, 3B, and/or 3C. While these flowpaths are shown as having right angles, a series of oblique angles, obtuse angles, or combination thereof could be used on a single facing. In the same manner, curving angles may be used in place of or in addition to the distinctive, sharp angles described above. Thus, a serpentine (i.e., S shape, Z shape, or C shape) may be provided. In all instances, the tortuous flowpath effectively rotates the orientation of the flowpath by a discernible amount, preferably at least 45 degrees (i.e., a V shape), at least 90 degrees (i.e., an L shape), or a full 180 degrees (i.e., a U-shape). Further, a series of the aforementioned angles or curves may be provided on a single facing (i.e., a W shape, an N shape, an M shape, a 3 shape, etc.).

Further, in some embodiments, the tortuous path is repeated on a plurality of facings of the insert, so as to create a flow path from the top edge adjacent to facing 121 to the bottom edge adjacent to facing 123. The path may carry onto the facings 121 and/or 123 themselves, thereby creating a connection well 121a as shown in FIG. 3A. Additionally or alternatively, one (or both) of the paths may terminate at the interface of the sidewall 122 and the bottom 123, also as shown in FIGS. 3A and 3B.

In a preferred embodiment, the insert has at least one flat facing and, more preferably at least four flat facings. The tortuous path may also be circumscribed on the top and/or bottom facings. The term “flat” also encompasses convex and concave surfaces in some embodiments, as well as a facing that is perfectly parallel with a single geometric plane.

In this manner, an insert having a plurality of flat facings can include a polygonal cylinder. The cylinder may have parallel, flat top and bottom facings, or these top and bottom facings may be angled relative to one another. A preferred polygonal shape is a 4-sided, although 3-sided, 5-sided, 6-sided, 7-sided, 8-sided, and 12-sided shapes are also possible.

In some embodiments, the cylinder may be curving, such as circular or oval cylinder. In such continuously curving axial sidewalls where the sidewalls are parallel to the z-axis, the tortuous flowpath necessarily changes direction multiple times in that z-axis while it conforms to the curving surface. In this manner, fluid introduced at one end is impeded and cannot flow freely down the z-axis by the force of gravity. Stated differently, the flowpath does not form a uniform helix and, instead zig-zags up and down along the z-axis multiple times, in addition to circumscribing the curved sidewalls.

In all instances, the cylindrical insert is sized to fit within a void between the dispenser and container. More specifically, the insert should occupy a space immediately proximate to the venting aperture admitting air into the container after a dispensing event on one end and the external, ambient environment on the opposing end. That is, one end of the tortuous path connects to the venting aperture and the other end of the tortuous path is exposed to the ambient environment. In the alternative, it is also possible to connect the apertures to a midpoint of the tortuous path that is set apart by some distance in comparison to the other, including the possibility of simply having the apertures connect along different facings of the insert.

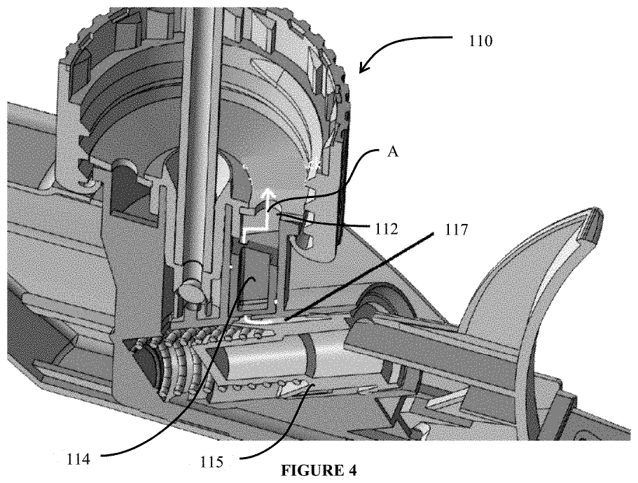

In this manner, air flows freely through the conduit 120 after normal trigger actuation, so as to allow to allow make-up air to flow along line A from the void 117 back through aperture 112 (and into the container's interior volume), as shown in FIG. 4. However, the multiple turns in the conduit 120 make it difficult for liquid to progress through the insert during e-commerce shipping or other non-actuation events (e.g., accidental inversion) where liquid from the container comes into contact with/passes through aperture 112.

The insert itself can be molded or formed so that the tortuous path is integrated therein. Portions of the path may even penetrate the interior of the insert, so long as the path is clearly defined and remains as a single conduit. Alternatively, the path can be machined, drilled, or otherwise imprinted or imparted onto and/or into the insert after the insert has been formed as a monolithic piece.

In order to determine the efficacy of a tortuous path and/or insert shape combination, a simple, qualitative “burp test” can be performed. Here, a trigger/container combination is weighed when empty and then again after a defined amount of fluid, such as a dyed water, has been introduced. The point where ambient air is introduced into the trigger mechanism is wrapped in an absorbent cloth, and the trigger/container combination is dropped from a defined distance for a number of times. The cloth is removed and inspected for visual evidence of fluid loss via “burping.” The trigger/container combination may also be weighed to further confirm or possibly even quantify the amount of fluid loss. Other iterations of this procedure are also possible, and it should be particularly useful in comparative analysis to test the efficacy of two or more designs.

Additionally, any chevron, insert, or other mechanism intended to prevent burping and fluid loss must still admit sufficient ambient air into the container so as to ensure a vacuum-induced deformation and/or dispensing issues do not occur. To that end, a test to confirm the vent is operating properly (e.g., not block, not clogged, etc.) can also be performed. Here, the container is filled with a fluid such as water, and the trigger is secured. The trigger is then actuated 20 times at a speed of 60 strokes per minute. Any deformation of the container indicates insufficient ambient air is being admitted during dispensing/trigger actuation. As above, this test can be particularly useful in determining whether the conduit is of sufficient size to allow for normal and intended operation of the trigger sprayer.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The features of each embodiment described and shown herein may be combined with the features of the other embodiments described herein. The claims as follows are intended to include all modifications and alterations insofar as they come within the scope of the claims or the equivalent thereof.

We claim:

1. A container comprising:
a dispenser selectively ejecting fluid from a sealed container when the dispenser is actuated;
a venting component forming a tortuous flowpath circumscribed on a plurality of facings of the component; and
a venting aperture on the dispenser, said venting aperture communicating with the tortuous flowpath when the dispenser to selectively admit ambient air into the container.

2. The container according to claim 1 wherein the venting component comprises an insert fitted within a void space on an interior of the dispenser, said void space disposed between a pump and the venting aperture.

3. The container according to claim 2 wherein the tortuous flowpath includes a passageway that orthogonally changes direction at least once on at least one facing of the component.

4. The container according to claim 3 wherein the orthogonal change of direction occurs on every facing of the component.

5. The container according to claim 2 wherein the tortuous flowpath forms at least one U shape on at least one of the facings of the component.

6. The container according to claim 2 wherein the tortuous flowpath forms a U shape on every of the component.

7. The container according to claim 2 wherein the tortuous flowpath forms at least one shape on each facing and wherein the at least one shape is selected from: a U shape, an S shape, a C shape, a V shape, a W shape, an N shape, an M shape, a 3 shape, combinations of any two or more shapes, and repeating patterns of similar or differing shapes.

8. The container according to claim 2 wherein the component is a polygonal cylinder with a plurality of sidewalls and the tortuous flowpath is circumscribed on at least two of the sidewalls.

9. The container according to claim 8 wherein the polygonal cylinder has four side facings.

10. The container according to claim 2 wherein the component includes a top facing and the tortuous flowpath is circumscribed on the top facing.

11. The container according to claim 10 wherein the top facing is angled so that at least one sidewall has a longer length than a sidewall positioned opposite thereto.

12. The container according to claim 10 wherein the component includes a plurality of side facings and at least one of those side facings is concave or convex relative to other side facings.

13. The container according to claim 1 wherein the venting component cooperates with at least one of: a closure, the dispenser, and the container to define the tortuous path.
